(19) United States
(12) Patent Application Publication
(10) Pub. No.: US 2026/0251231 A1
(43) Pub. Date: Aug. 27, 2026

(54) RUPTURE DISK WITH LIMITED OPENING ANGLE

(71) Applicant: REMBE GmbH Safety + Control, Brilon (DE)

(72) Inventors: Volker HENKE, Brilon (DE); Stefan PENNO, Brilon (DE); Marius BLOCHING, Willich (DE)

(21) Appl. No.: 19/531,077

(22) Filed: Feb. 5, 2026

(30) Foreign Application Priority Data
Feb. 25, 2025 (EP) 25160004.5

(51) Int. Cl. F16K 17/40

(52) U.S. Cl. CPC F16K 17/403

(57) ABSTRACT

A band is designed to limit the opening angle of a rupture disk having a central area, a first edge area along which the central area of the rupture disk is capable of swiveling to release pressure, and two second edge areas arranged opposite each other perpendicular to the first edge area. The band includes: a first end having a first fastening element and a second end having a second fastening element. The first and second fastening elements are fastenable to the two second edge areas of the rupture disk, respectively, such that in a fastened state the band extends between the two second edge areas of the rupture disk and spans across the rupture disk. A length of the band between the second edge areas is extendable to a predetermined limit in response to a rupture of the rupture disk.

### CROSS REFERENCE TO RELATED APPLICATIONS

This application claims priority under 35 U.S.C. § 119(a)-(d) to European application No. 25160004.5, filed on February 25, 2025, the entire contents of which are hereby incorporated by reference.

### TECHNICAL FIELD

The present disclosure relates to a device for limiting the opening angle of a rupture disk, in particular a rupture disk made of sheet metal, with edge areas with which the rupture disk can be attached to an opening of a container or a pipe, and with a central area with which the opening can be closed up to a rupture pressure, and with predetermined breaking lines along which the rupture disk tears open when the rupture pressure is reached, so that the central area opens completely or in parts.

### BACKGROUND

Such a rupture disk is known from document EP 4 477 925 A1. The rupture disk known from the document is angular, in particular rectangular, and has a fold in the edge areas, which comprises a first folded part of the sheet metal and a second part of the sheet metal to which the folded part is parallel or predominantly parallel.

Document EP 2 532 933 B1 discloses a device for limiting the opening angle of the rupture disk, which can be attached together with a rupture disk to an opening of a container or a pipe.

Rupture disks seal an opening in a wall, floor, or ceiling during normal operation of a technical facility that needs to be protected. In the event of overpressure, particularly as a result of an explosion or negative pressure, the rupture disk ruptures and can thus ensure pressure equalization between the cavity in the technical facility to be protected and the area surrounding this technical facility without destroying the technical facility itself. The advantage of rupture disks is that they provide pressure relief at a specific position in the protected technical equipment, namely at the position where the rupture disk is installed. At the position where the rupture disk is installed, a pressure wave and/or flame can escape from the protected equipment. It must therefore be ensured that the area in front of the rupture disk is clear so that the pressure wave and/or flame cannot cause damage to objects or persons. The rupture disk must therefore be installed at a position on the protected equipment where the pressure wave and/or flame can spread unhindered into the surrounding area. This means that the selection of positions on the technical equipment where a rupture disk can be installed is restricted, for example, by the build out in the surrounding area. Similarly, if the equipment protected by the rupture disk is already in place, the layout of the surrounding area cannot be carried out without taking the existing rupture disk into account.

A device that limits the opening angle of a rupture disk can provide a remedy. By limiting the opening angle of the rupture disk, the direction of propagation of a pressure wave and/or flame can be influenced. The device can be used to ensure that, in the event of relief, the rupture disk does not swivel up to 180° from its starting point as usual, but rather swivels at smaller angles. This allows the rupture disk to direct the pressure wave and/or flame in a preferred direction. This makes it possible to choose the position where the rupture disk is installed more freely and to lay out the surrounding area of the protected technical equipment more freely.

Devices for limiting the opening angle of a rupture disk are known from various documents and also from practice, for example, the devices from documents US 6,192,914 B2, DE 202 15 501 U1, and EP 2 532 933 B1, or the TARGO-VENT product of the applicant, or the VIGISPACE product from STIF - Société de Tôlerie Industrielle Française.

The device known from document US 6,192,914 B2 is used on a rupture disk in a pipe and is formed by a catcher bar. This catcher bar supports a hinge area of the rupture disk when the rupture disk flips over and tears open, and brakes the movement of the central area ("blow-out portion") of the rupture disk when it bends into the free interior of a pipe socket. The supporting of the hinge area and the braking of the central area of the rupture disk by the catcher bar prevents the central area from being separated or torn off from the rest of the rupture disk. The function of the catcher bar is therefore also to prevent the central area of the rupture disk from being separated or torn off. When the rupture disk known from document US 6,192,914 B2 is folded out and torn open, the central area strikes the catcher bar. The opening angle of the rupture disk is always limited to 90° by the catcher bar. This may be sufficient for relieving excess pressure in a pipeline. However, this is not sufficient for applications in which the pressure is relieved into the surrounding area of the device to be protected.

The device for limiting the opening angle known from document DE 202 15 501 U1 is formed by triangular pieces attached to the side of the rupture disk, referred to as bellows in the utility model specification, which are made of a flexible material not specified in detail in the utility model specification. One side of triangular pieces are attached with one edge of the opening closed off by the rupture disk. Another side is attached to one edge of the rupture disk. The device known from document DE 202 15 501 U1 has not become established in practice.

The device for limiting the opening angle known from document EP 2 532 933 B1 comprises a plate with a central area that can be bulged (deformed) and/or deflected under force perpendicular to the plane of the plate, wherein the plate comprises edge areas on opposite sides of the central area with which the plate can be fastened, and wherein edge areas of the rupture disk and the edge areas of the plate lie on top of each other. In the event of the tearing open of the rupture disk, the central area of the rupture disk presses on the central area of the plate and bulges it out. This allows the rupture disk to open, but not to flip over completely. The opening angle is limited.

The TARGOVENT of the applicant is a technical implementation of the teaching of document EP 2 532 933 B1. A flexible material is used as the plate in the TARGOVENT.

The VIGISPACE from STIF is a catch basket that catches the central area of the rupture disk.

In contrast to the VIGSPACE, the mechanisms or devices for limiting the opening angle known from document DE 202 15 501 U1 and document EP 2 532 933 B1 and the TARGOVENT do not protrude significantly beyond the rupture disk. The mechanisms or devices take up hardly any additional space. In particular, the devices do not protrude into traffic routes that pass by the rupture disks. Likewise, the rupture disks with the mechanisms or devices for limiting the opening angle can also be used on mobile installations, the dimensions of which are then not increased by protruding parts of the mechanisms or devices for limiting the opening angle.

### SUMMARY

The disclosed rupture disk is based on the task of proposing a device that is less complex than the TARGOVENT, but at the same time has the advantage of the small dimensions of the TARGOVENT. As described herein, this task is solved by a band having the following features:

The band comprises elements of the band elements or the band is at least partially formed from a material by which the length or alternatively the one length of the band is extendable to a limited extent.

Accordingly, a device is described that limits the opening angle of a rupture disk has a plate which:

comprises a first area that can be bulged (deformed) and/or deflected under the action of a force perpendicular to the plane of the plate, and

comprises a second area with which the plate can be fastened,

wherein the second area is provided at a first edge of the plate, and

wherein the plate comprises two second edges that are substantially perpendicular to the first edge.

This device is attachable to the outside of a rupture disk, which in particular is a rectangular one. For this purpose, the second area is attached to a first edge area of the rupture disk, along which the central area of the rupture disk swivels when pressure is released. Arranged perpendicular to this first edge area, the rupture disk comprises two second edge areas opposite each other. One or more predetermined breaking lines are provided between the second edge areas and the central area of the rupture disk. At least one further predetermined breaking line is provided on a third edge area of the rupture disk, which is opposite the first edge area of the rupture disk. The rupture disk tears open along these predetermined breaking lines in the event of pressure relief.

Just as the central area of the rupture disk swivels about this first edge area of the rupture disk when the rupture disk opens, the first area of the plate of the described device swivels about the second area of the plate. Depending on how rigid the plate is, particularly in the swiveling area, the movement of the central area of the rupture disk is braked and/or dampened. By selecting the properties of the plate, for example, the thickness of the plate, it is possible to adapt the dampening of the movement, wherein the opening angle of the rupture disk is limited.

The fastening elements at the ends of the band of the described device are attached to second edge areas of the rupture disk. When opening, the swiveling first area of the plate presses on the band, the ends of which remain held at the second edge areas of the rupture disk. Inasmuch as the band is extendible, the first area of the plate and the central area of the rupture disk can bulge (deformed) and/or deflect. This enables the swiveling of the central area of the rupture disk and of the first area of the plate of the described device.

Inasmuch as the extension of the band is limited, the swiveling movement stops when the maximum length of the band is reached. The opening angle of the rupture disk is thereby limited. A flow discharged from the container secured with the rupture disk is thus directed in a desired direction by the opening angle of the rupture disk.

A material that allows a limited extension of the band could be a flexible or stretchable material.

It could also be that the band is corrugated or has a zigzag pattern and is pulled smooth when the limited extension occurs. Such a corrugated or zigzag band could be made of steel or a composite material.

If elements for limited extension of the band are provided, the band may be made of a rigid material that is not stretchable or only slightly stretchable, such as steel or a composite material, in particular a fiber composite material such as carbon fiber reinforced plastic.

It is possible that the elements for the limited extension of the band are only provided in an area between the first and second band ends. In particular, they may also be arranged only in a central area of the band.

The extendibility of the band can be realized easily if the band is divided into two parts and comprises a first band section and a second band section. In particular, the first band section can comprise the first band end and the second band section can comprise the second band end. In particular, the first band section could comprise some of the elements for limited extension and the second band section could comprise some of the elements for limited extension.

Both the first band section as well as the second band section can be connected to each other in a displaceable manner by the elements for limited extension, wherein the displaceability of the two band sections relative to each other is limited to a predetermined path.

Guide elements and stop elements may belong to the elements for limited extension of the described device.

It is thus possible for both the first band section as well as also the second band section respectively to have at least one guide element, wherein the at least one guide element of the first band section and the at least one guide element of the second band section together form a guide that enables the extension.

Both the first band section as well as also the second band section of the described device may respectively comprise at least one stop element. The at least one stop element of the first band section and the at least one stop element of the second band section may form stops for each other, which is to say, they may strike against each other. The stop elements may limit the extension of the band.

The first band section and the second band section may each have a first area, wherein the first area of the second band section is wider than the first area of the first band section and the first area of the first band section is wider than a second area of the second band section.

Then, the first area of the first band section can have a slot as the guide element or one of the guide elements of the first band section. The second area of the second band section can be displaceably guided as the guide element or one of the guide elements of the second band section.

Alternatively or additionally, the first area of the second band section may have edges lying in the direction of displacement. These edges may be bent about edges of the first area of the first band section lying in the direction of displacement. In this way, these edges of the two band sections may form the guide elements or one of the plurality of guide elements of the band sections.

A limitation or edge of the slot in the first area of the first band section may form the stop element or one of the plurality of stop elements of the first band section. Then, a shoulder or projection on the second band section, in particular a shoulder between the first area of the second band section and the second area of the second band section, can form the stop element or one of the plurality of stop elements of the second band section.

In the plate of the described device, two first recesses may be provided in the first area at a distance from each other. The band may be guided from a first side to a second side of the plate through these first recesses.

The plate of the described device may comprise a second recess in the first area. The center of the band may be arranged in this recess. This second recess may be an indentation in the first area of the plate, extending from the edge of the first area that is opposite to the second area of the plate toward the second area.

The problem underlying the described arrangement is also solved by a rupture disk made of sheet metal, which has edge areas with which the rupture disk can be attached to an opening of a container or a pipe, which has a central area with which the opening of the container or the pipe is closed until reaching a rupture pressure, and which has predetermined breaking lines along which the rupture disk ruptures when the rupture pressure is reached, so that the central area opens completely or in parts, wherein the rupture disk has the described device for limiting the opening angle of the rupture disk.

In the described rupture disk, at least one of the edge areas or the central area of the rupture disk and the plate of the device for limiting the opening angle of the rupture disk may consist of a single piece.

### BRIEF DESCRIPTION OF THE DRAWINGS

Further features and advantages of a disclosed embodiment are described below with reference to the drawings.

FIG. 1 shows a perspective view of a rupture disk according to the disclosure with a device that limits the opening angle of the rupture disk.

FIG. 2 shows a top view of the rupture disk.

FIG. 3 shows a top view of the rupture disk without a band of the device that limits the opening angle.

FIG. 4 shows a top view of the band of the device that limits the opening angle.

FIG. 5 shows a detailed view of the center of the band of the device that limits the opening angle.

FIG. 6 shows a detail of a first band section in perspective view.

FIG. 7 shows a detail of a second band section of the band in perspective view.

FIG. 8 shows a band of a variant of the rupture disk according to FIG. 1 through FIG. 7.

### DETAILED DESCRIPTION

It is not necessary for the described rupture disk B or the limiting device to comprise all of the features described below. It is also possible for a device according to the disclosure to have only certain features of the embodiments described below.

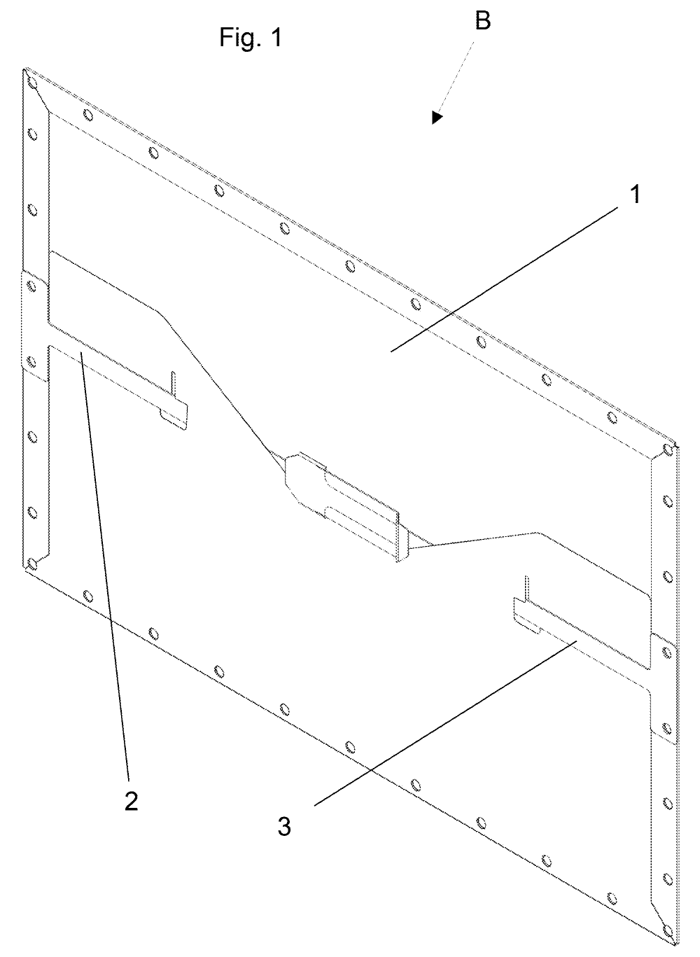

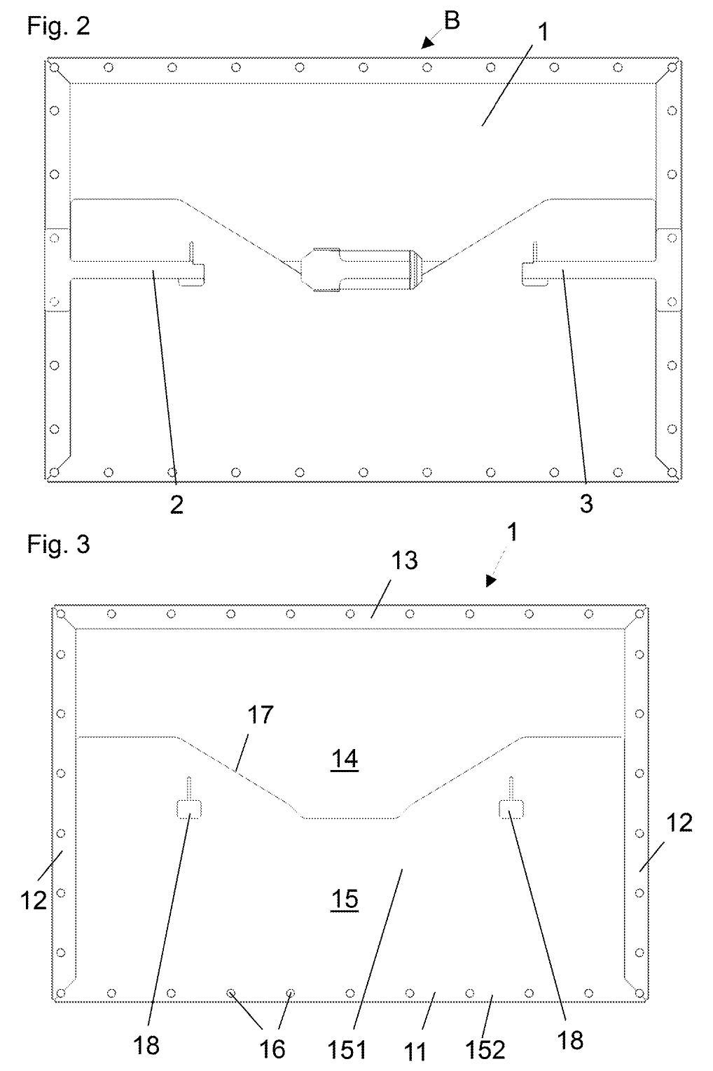

As shown in FIGS. 1 and 2, the disclosed rupture disk is made from three pieces of sheet metal 1, 2, 3. The largest piece of sheet metal 1 forms the edge areas 11, 12, 13 of the rupture disk B, a central area 14 of the rupture disk B, and the plate 15 of a limiting device that limits the opening angle of the rupture disk B, which is part of the rupture disk B, as shown in FIG. 3.

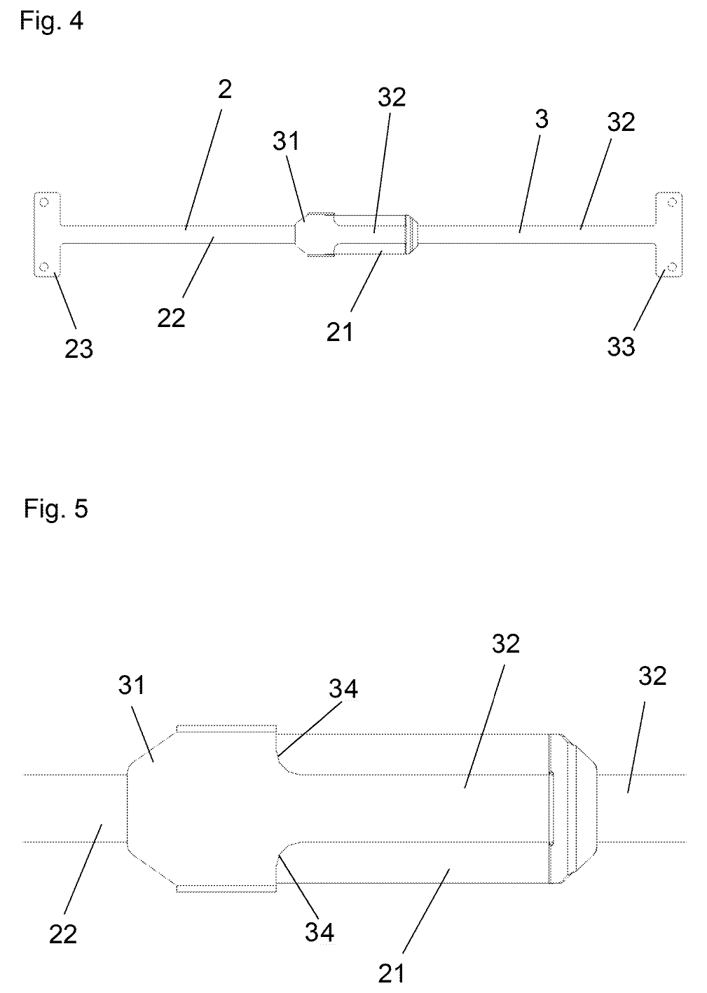

The two other, smaller sheet metal pieces 2, 3 respectively form a first or alternatively a second band section 2, 3, which together form a band 2, 3 of the limiting device that limits the opening angle of the rupture disk B, as shown in FIGS. 2 and 4.

The central area 14 of the largest sheet metal piece or alternatively the rupture disk B is rectangular. The central area 14 is adjoined on each side by an edge area 11, 12, 13. The central area 14 swivels (pivots) about a pivot axis lying along a line between a first of the edge areas 11 and the central area 14 of the rupture disk when the rupture disk B opens, with the pivot axis extending from the left edge area 12 to the right edge area 12. Second edge areas 12 are provided opposite one to the other on edges of the central area 14 perpendicular thereto. These are separated from the central area 14 by predetermined breaking lines. A third edge area 13 is located opposite the first edge area 11. This too is also separated from the central area 14 by a predetermined breaking line.

The largest sheet metal piece 1 has a fold in the second and third edge areas 12, 13. This fold has a first folded part of sheet metal piece 1 and a second part of sheet metal piece 1, to which the folded part is parallel or predominantly parallel and which is connected to the central area 14. The first, folded part of the sheet metal piece 1 extends to the central area 14 or even overlaps slightly with the central area 14, which is to say, it protrudes beyond the predetermined breaking line between the second, non-folded part and the central area 14.

The largest sheet metal piece 1 also comprises a fold in the first edge area 11. This fold also has a first folded part 15 of the sheet metal and a second part of the sheet metal to which the folded part is parallel or predominantly parallel and which is substantially formed by the central area 14. The first folded part 15 of the sheet metal is, however, significantly longer than the first folded parts of the folds of the other edge areas 12, 13. This protrudes, in part, significantly beyond the center between the first edge area 11 and the third edge area 13. This first folded part 15 of the fold in the first edge area of the rupture disk forms the plate 15 of the limiting device that limits the opening angle of the rupture disk B. As shown in FIG. 3, of this, the part of the plate 15 overlapping the central area 14 of the rupture disk B forms the first area 151 of the plate 15, which is bulged out (deformed) and/or deflected when the plate 15 is opened under the action of the force acting perpendicular to the plane of the plate 15 when the rupture disk B is opened. The second area 152 of the plate is formed by the first, folded part of the fold in the first edge area 11.

Holes 16 are provided in the edge areas 11, 12, 13, through which screws can be inserted to attach the rupture disk B to the container or pipe to be protected.

The two smaller sheet metal pieces 2, 3 of the rupture disk B, which form the first or alternatively second band pieces 2, 3 of the band 2, 3, each comprise a fastening element 23, 33 at one outer end (see FIG. 4). These fastening elements 23, 33 each comprise two holes that are aligned with two holes in the second edge areas 12. The band sections 2, 3, together with the largest sheet metal piece 1 of the rupture disk, can thus be screwed to the container or pipe to be secured.

The band sections 2, 3 extend inward from the fastening elements 23, 33 to the respective opposite second edge area 12. They extend beyond the center between the second edge areas 12, and the ends are connected to each other such that they can shift relative to each other. This allows the band 2, 3 to be extended and to follow any bulging and/or deflection of the first area 151 of the plate 15 or alternatively the central area 14 of the rupture disk B. However, the displacement of the ends of the two band sections 2, 3 is only possible to a limited extent. Stop elements 211, 34, shown respectively in FIGS. 7 and 5, at the ends of the band sections 2, 3 ensure that the ends of the band sections 2, 3 can be displaced relative to each other only by a certain distance.

Guide elements are provided at the ends of the two band sections 2, 3 to guide the ends. A stop element is provided at the ends of each band section to limit the displacement of the ends relative to each other and thus to limit the extension of the band.

As shown in FIGS. 5-7, the first band section 2 and the second band section 3 each comprise a first area 21, 31 which is located at the end of the first or alternatively second band section 2, 3 that is connected to the other band section 2, 3. A second area 22, 32 is provided between the first area 21, 31 and the fastening element 23, 33 for each of the two band sections 2, 3. The first area 21, 31 of the two band sections 2, 3 is wider than the second area 22, 32 of the same band section 2, 3.

In addition, the first area 31 of the second band section 3 is wider than the first area 21 of the first band section 2, and the first area 21 of the first band section 2 is wider than a second area 32 of the second band section 3.

The first area 21 of the first band section 2 has a slot 212 as the first of two guide elements of the first band section 2 (see FIG. 7). The second area 32 of the second band section 3 is guided through this slot 212. This second area 32 is one of two guide elements of the second band section 3. The second area 32 is guided in a displaceable manner in the slot 212.

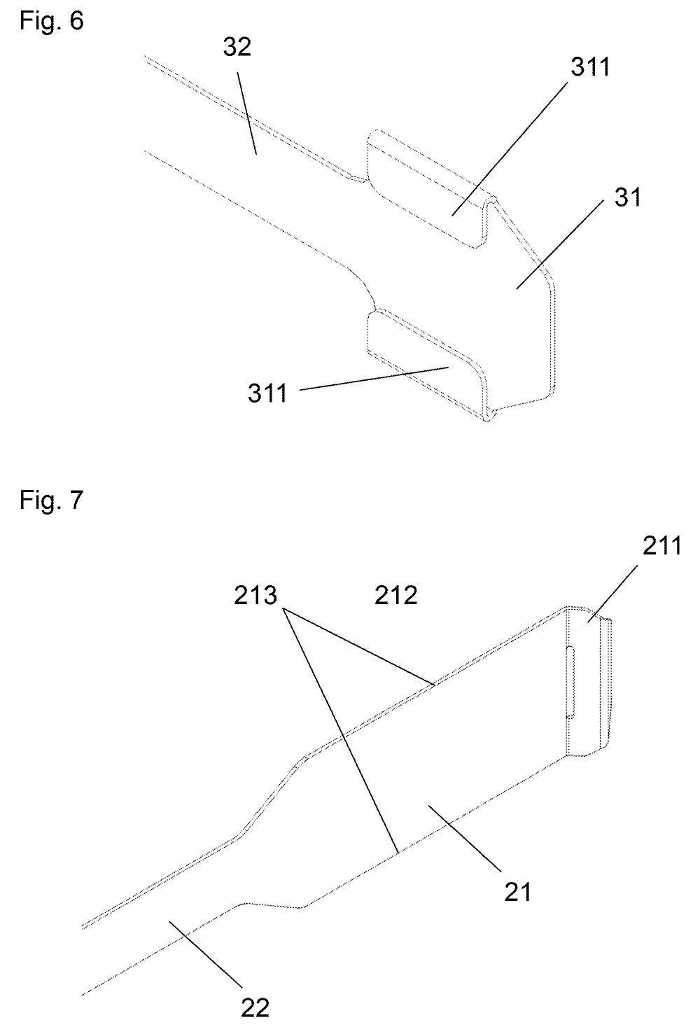

In addition, the first area 32 of the second band section 3 has edges 311 lying in the direction of displacement (see FIG. 6). These are wrapped around the edges 213 of the first area 21 of the first band section 2 that lie in the direction of displacement and thus enclose them. In this way, these edges 311, 213 of the two band sections 2, 3 each form second guide elements of the band sections 2, 3.

A limitation or edge of slot 212 in the first area 21 of the first band section 2 forms the stop element 211 of the first band section 2. A shoulder between the first area 31 of the second band section 3 and the second area 32 of the second band section 3 forms the stop element 34 of the second band section 2. In the event of a bulging (deformation) or deflection of the first area 151 of the plate 15 or alternatively the central area 14 of the rupture disk B, the two stop elements strike each other and thereby limit the movement of the ends of the band sections 2, 3 relative to each other and the extension of the band 2, 3.

In order for the first area 151 to not slip under the extending band 2, 3 in the event of a bulging or deflection of the first area 151 of the plate 15 or alternatively of the central area 14 of the rupture disk B, two openings 18 are provided in the first area 151 of the plate 15, through which openings the band 2, 3 is guided from the front to the back of the plate 15. The second areas 22, 32 of the band sections 2, 3 are guided through the openings 18. The edge of the first area 151 of the plate 15 has an indentation 17 in the direction of the second area 152 of the plate 15. This indentation 17 releases the second areas of the band sections 2, 3, which can be displaceable relative to each other, and prevents the band sections from being pinched between the first area of the plate 15 and the central area 14 of the rupture disk B, which could impair the movement of the two band sections 2, 3 relative to each other.

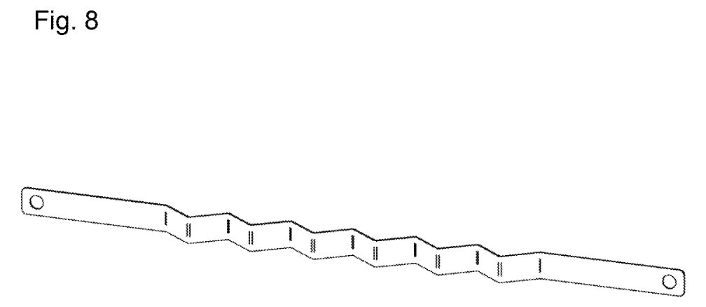

The band shown in FIG. 8 could be part of a rupture disk according to another implementation instead of the band shown in FIGS. 1, 2 and 4-7. The band has a zigzag or corrugated shape. The force acting on the band when the rupture disk is opened stretches and smooths the congregations of the band. This allows a limited extension of the band.

What is claimed is:

1. A band for limiting an opening angle of a rupture disk comprising a central area, a first edge area along which the central area of the rupture disk is capable of pivoting to release pressure, and two second edge areas arranged opposite each other perpendicular to the first edge area, the band comprising:
a first end comprising a first fastening element; and
a second end comprising a second fastening element, the first and second fastening elements being fastenable to the two second edge areas of the rupture disk, respectively, such that, in a fastened state, the band extends between the two second edge areas of the rupture disk and spans across the rupture disk,
wherein a length of the band between the two second edge areas is extendable to a predetermined limit in response to a rupture of the rupture disk.

2. The band of claim 1, further comprising:
a first band section including the first end of the band; and
a second band section including the second end of the band,
wherein the first band section is slidably engaged with the second band section.

3. The band of claim 2, wherein the first band section comprises a first area and a second area, and the second band section comprises a first area and a second area, wherein the first area of the first band section slidably engages the first area of the second band section.

4. The band of claim 3, wherein the first area of the first band section includes side edges that extend in a direction in which the band is extendable, and the first area of the second band section includes side edges that extend in the direction in which the band is extendable, the side edges of the first area of the second band section being bent around the side edges of the first area of the first band section to form slidably engaged guide elements.

5. The band of claim 3, wherein the first areas of the first and second band sections comprise respective elements that interact to limit extension of the band to the predetermined limit.

6. The band of claim 3, wherein the first area of the first band section includes a first guide element and a first stop element, and the first area of the second band section includes a second guide element and second stop element, the first and second guide elements providing slidable engagement between the first and second band sections to enable extension of the band, and the first and second stop elements being positioned to limit extension of the band to the predetermined limit.

7. The band of claim 3, wherein the first area of the first band section is wider than the second area of the first band section, and the first area of the second band section is wider than the second area of the second band section.

8. The band of claim 7, wherein the first area of the first band section includes a slot comprising a first guide element of the first band section, and the second area of the second band section comprises a second guide element, the second guide element being displaceably guided through the first guide element.

9. The band of claim 8, wherein:
side edges of the slot in the first area of the first band section comprise a first stop element;
a shoulder between the first area of the second band section and the second area of the second band section comprises a second stop element; and
engagement of the first and second stop elements limits extension of the band to the predetermined limit.

10. The band of claim 2, wherein the first band section further includes a first stop and the second band section include a second stop, wherein engagement of the first and second stops limits extension of the band to the predetermined limit.

11. The band of claim 2, wherein the first band section and the second band section are connected to each other in a displaceable manner along a predetermined path by elements that interact to limit extension of the band to the predetermined limit.

12. The band of claim 1, further comprising:
a first band section including the first end of the band and a first guide element; and
a second band section including the second end of the band and a second guide element,
wherein a guide comprising the first guide element and the second guide element enables extension of the band.

13. The band of claim 1, wherein the band includes corrugations configured to stretch to enable the length of the band to extend to up to the predetermined limit in response to a rupture of the rupture disk.

14. A plate for limiting an opening angle of a rupture disk for pressure relief, the plate comprising:
a first area capable of being deformed or deflected by a force perpendicular to a plane of the plate;
a second area at a first edge of the plate and configured to fasten the plate to another structure; and
two second edges oriented substantially perpendicular to the first edge.

15. The plate of claim 14, further comprising:
first and second openings in the first area, the first and second openings being shaped to receive a band fastened to and extending between the two second edges.

16. The plate of claim 15, wherein:
on a side of the first area opposite the second area, an edge of the first area extending between the two second edges includes an indentation between the first and second openings; and
a center of the band is arranged in the indentation.

17. The plate of claim 16, wherein the plate consists of a single piece of sheet metal.

18. A rupture disk, comprising:
edge areas configured to fasten the rupture disk to an opening of a container or pipe;
a central area with which the opening is closeable until reaching a rupture pressure;
predetermined breaking lines along which the rupture disk ruptures in response to the rupture pressure being reached, such that the central area opens completely or in parts; and
a band arranged to limit an opening angle of the rupture disk, the band including a first end fastened to one of the edge areas and a second end fastened to another of the edge areas opposite said one of the edge areas such that the band extends across the central area, wherein a length of the band is extendable to a predetermined limit in response to rupture of the rupture disk.

19. The rupture disk of claim 18, further comprising:
a plate comprising:
a first area extending over at least a portion of the central area of the rupture disk, the first area of the plate being deformable or deflectable by a force perpendicular to a plane of the plate;
a second area at a first edge of the plate located along yet another of the edge areas of the rupture disk; and
first and second openings in the first area, the band being threaded through the first and second openings.

20. The rupture disk of claim 18, wherein the rupture disk is a sheet metal rupture disk.
